(19) United States
(12) Patent Application Publication
(10) Pub. No.: US 2012/0073741 A1
(43) Pub. Date: Mar. 29, 2012

(54) ADHESIVE COMPOSITION

(75) Inventors: Takahiro Asai, Kawasaki-shi (JP); Hirofumi Imai, Kawasaki-shi (JP); Koki Tamura, Kawasaki-shi (JP); Takahiro Yoshioka, Kawasaki-shi (JP); Nobuyuki Matsuoka, Kakogawa-shi (JP); Mariko Watanabe, Kakogawa-shi (JP); Takahiko Tsukuda, Kakogawa-shi (JP)

(73) Assignees: HARIMA CHEMICALS, INC., Kakogawa-shi (JP); TOKYO OHKA KOGYO CO., LTD., Kawasaki-shi (JP)

(21) Appl. No.: 13/375,163

(22) PCT Filed: May 20, 2010
(86) PCT No.: PCT/JP2010/058558

§ 371 Date: Nov. 29, 2011

(30) Foreign Application Priority Data
Jun. 11, 2009 (JP) 2009-140170

(51) Int. Cl. B32B 38/10; C09J 11/08; C09J 145/00; C09J 157/00; C09J 193/04

(52) U.S. Cl. 156/247; 524/499; 524/274; 524/554

(57) ABSTRACT

An adhesive composition for forming an adhesive layer for temporarily fixing a substrate, such as a wafer, to a support when processing the substrate, the adhesive composition including a resin (A) produced by polymerizing a monomer component containing a cycloolefin-based monomer, at least one terpene-based resin, rosin-based resin, or petroleum resin (resin B), and an organic solvent capable of dissolving the resins (A) and (B). The resin (A) has a glass transition point of 60° C. or higher, the resin (B) has a softening point of 80 to 160° C. and a molecular weight of 300 to 3000, and the blending ratio of the resin (A) to the resin (B) is (A):(B)=80:20 to 55:45 (mass ratio).

### TECHNICAL FIELD

The present invention relates to adhesive compositions and more particularly to adhesive compositions for temporarily fixing a substrate, such as a semiconductor wafer, to a support, such as a glass plate or a film, in processing such a substrate.

### BACKGROUND ART

In the production of thin semiconductor silicon chips, for example, high-purity silicon single crystal or the like is sliced to form a wafer and then a prescribed circuit pattern is formed on the wafer surface using a photoresist. Subsequently, the resulting semiconductor wafer is ground on its rear surface and then the silicon wafer having been ground to a prescribed thickness is subjected to dicing, so that chips are obtained.

In such a production process, the thinned wafer needs to be reinforced because the thinned wafer itself is brittle and easy to break. In addition, it is also necessary to prevent the circuit pattern formed on the wafer surface from being polluted by, for example, swarf or the like generated in the grinding process. The following methods are known as methods for preventing breakage of a wafer and protecting a circuit pattern on a wafer surface.

(1) A method that includes performing grinding with a support being fixed to a wafer temporarily with an adhesive layer, and then peeling the support (Patent Documents 1 and 2).
(2) A method that includes performing grinding with a pressure-sensitive adhesive film having an adhesive layer being attached to a circuit pattern surface of a wafer surface, and then peeling the adhesive film (Patent Documents 3 and 4).

Incidentally, under recent increasing demands for the miniaturization, thickness reduction and advances in function of electronic devices, for example, a penetrating electrode formation technology in which a chip with a penetrating electrode is stacked to form bumps on the rear side of the chip has been attracting much attention as a method for wiring an electrode (bump) to a circuit board in system-in-package (SiP) in place of a wire bonding technology, which was the mainstream conventionally. In order to apply this penetrating electrode formation technology, a chip with a penetrating electrode must be produced by forming the penetrating electrode in a semiconductor wafer ground in a prescribed thickness. For that purpose, many steps including a high temperature process and a high vacuum process need to be carried out.

However, in the techniques of Patent Documents 1 through 4 for preventing breakage of a wafer and protecting a circuit pattern on a wafer surface, adhesives having been used for an adhesive layer for temporarily fixing a support or an adhesive layer for adhering a pressure-sensitive adhesive film do not have sufficient heat resistance. Therefore, when attaching a support or a pressure-sensitive adhesive film to a semiconductor wafer, subsequently applying grinding process and then attempting to form a penetrating electrode, there is a problem that adhesion strength is lowered by degradation of the resin in the adhesive layer due to exposure to high temperature in a process of forming the penetrating electrode. Also, there is another problem that moisture absorbed by the adhesive layer is transformed into a gas at high temperature and the gas causes bubble-like peeling in the adhesive layer to cause defective adhesion. Moreover, there is a problem that when peeling the adhesive layer (a support or an adhesive film), defective peeling, such as remaining of a residue at the time of peeling, occurs easily if the adhesive layer is exposed once to high temperature. Furthermore, in the case that the formation of a penetrating electrode is done under a high-temperature, high-vacuum environment, a gas generated due to the decomposition of the adhesive layer itself at high temperature or a gas generated from moisture of the adhesive layer not only causes defective adhesion as described above but also causes prevention of maintenance of a vacuum environment.

Then, an adhesive composition primarily including a specific acrylic resin has been proposed as an adhesive composition which has good heat resistance and exerts sufficient adhesion strength under a high temperature environment (Patent Document 5). Moreover, an adhesive composition including an alicyclic structure-containing polymer having a specific molecular weight and a low molecular weight compound having another specific molecular weight has been proposed as an adhesive resin composition having heat resistance for the purpose of use in adhesion of electronic parts or substrates (Patent Document 6).

### PRIOR ART DOCUMENTS

### Patent Documents

[Patent Document 1] JP 7-224270 A
[Patent Document 2] JP 9-157628 A
[Patent Document 3] JP 2003-173993 A
[Patent Document 4] JP 2001-279208 A
[Patent Document 5] JP 2008-133405 A
[Patent Document 6] JP 11-269394 A

### SUMMARY OF THE INVENTION

### Problems to be Solved by the Invention

The adhesive composition disclosed in patent document 5 has a problem that when it comes into contact with various types of chemical liquids to be used for a photoresist or the like (typically, propylene glycol monomethyl ether acetate (PGMEA) and the like) during a process for forming a penetrating electrode, an adhesive layer is dissolved and degraded by such chemical liquids, so that a wafer surface is polluted.

On the other hand, the adhesive composition disclosed in patent document 6 has a problem that an adhesive layer easily absorbs moisture due to a polar group possessed by an alicyclic structure-containing polymer and, as a result, the amount of gas generated at high temperature increases, so that defective adhesion is caused, or a peeling rate is slow at the time of peeling an adhesive layer, so that a disadvantage is caused with respect to productivity.

A primary object of the present invention is to provide an adhesive composition suitable for forming an adhesive layer for temporarily fixing a substrate, such as a wafer, to a support, such as a glass plate or a film, when processing the substrate. That is, the present invention provides an adhesive composition, wherein the adhesive composition forms, in processing a substrate, an adhesive layer having heat resistance as high as no defective adhesion is caused by degradation of resin or generation of gas even upon exposure to high temperature and exhibiting sufficient resistance to various types of chemical liquids, such as PGMEA, to be used for a photoresist or the like, and the adhesive layer can be peeled rapidly after the processing of the substrate and is superior in flexibility.

### Means for Solving the Problems

The present inventors have studied earnestly in order to solve the above-described problems. As a result, they have chosen a resin (A) produced by polymerizing a monomer component containing a cycloolefin-based monomer (a1) as a resin which is superior in heat resistance and is difficult to dissolve in various types of chemical liquids such as PGMEA to be used for a photoresist or the like. Moreover, a peeling rate in peeling an adhesive layer is low if the resin (A) is used singly. Therefore, measures taken for compensating this include blending, as a peeling aid, at least one resin (B) which is superior in heat resistance like the resin (A), which is difficult to dissolve in various types of chemical liquids, such as PGMEA, to be used for a photoresist or the like, and which is selected from the group consisting of a terpene-based resin, a rosin-based resin, and a petroleum resin. They have found that an adhesive composition prepared by dissolving these two kinds of resins in a specified ratio in an organic solvent (S) can solve the above-described problems at once, which have led to completion of the present invention.

That is, the adhesive composition of the present invention is produced by dissolving a resin (A) produced by polymerizing a monomer component containing a cycloolefin-based monomer (a1) and at least one resin (B) selected from the group consisting of a terpene-based resin, a rosin-based resin, and a petroleum resin in an organic solvent (S). At this time, the glass transition point of the resin (A) is 60° C. or higher, the softening point of the resin (B) is 80 to 160° C., and the molecular weight of the resin (B) is 300 to 3000. Moreover, the blending ratio of the resin (A) to the resin (B) is (A):(B)=80:20 to 55:45 (mass ratio).

In addition, the method according to the present invention for processing a substrate has a feature that the method includes the steps of: temporarily fixing a support to a substrate such as a wafer with an adhesive layer interposed therebetween, processing the substrate including the step of heating the substrate, and peeling the support from the substrate with a solvent, wherein the adhesive layer is one formed from the above-mentioned adhesive composition.

### EFFECT OF THE INVENTION

According to the adhesive composition of the present invention, an adhesive layer that temporarily fixes a substrate such as a wafer to a support such as a glass plate or a film in processing the substrate can be formed. This adhesive layer has heat resistance as high as defective adhesion is not caused by degradation of resin or generation of gas even upon it is exposed to high temperature in processing the substrate. In addition, the adhesive layer exhibits sufficient resistance to various types of chemical liquids, such as PGMEA, to be used for a photoresist or the like. Moreover, it can be peeled rapidly after processing the support and it is superior in flexibility. This produces an effect that it becomes possible to form a penetrating electrode in a semiconductor wafer via processes including a high temperature process and a high vacuum process while preventing breakage of the wafer and protecting a circuit pattern formed on the wafer surface.

### EMBODIMENTS FOR CARRYING OUT THE INVENTION

The adhesive composition of the present invention is produced by dissolving a specific resin (A) and a specific resin (B) in an organic solvent in a specific ratio.

The resin (A) in the present invention is a resin produced by polymerizing a monomer component containing a cycloolefin-based monomer (a1). Specifically, examples of the resin (A) include ring-opened (co)polymers of a monomer component including the cycloolefin-based monomer (a1), and a resin produced by addition-(co)polymerizing a monomer component including the cycloolefin-based monomer (a1).

Examples of the cycloolefin-based monomer (a1) contained in the monomer component constituting the resin (A) include bicyclic monomers such as norbornene and norbornadiene, tricyclic monomers such as dicyclopentadiene and dihydroxypentadiene, tetracyclic monomers such as tetracyclododecene, pentacyclic monomers such as cyclopentadiene trimer, heptacyclic monomers such as tetracyclopentadiene, or the alkyl-substituted monomers, alkenyl-substituted monomers, alkylidene-substituted monomers, aryl-substituted monomers, and the like of the foregoing polycyclic monomers. Among these, norbornene-based monomers represented by the following general formula (1) and selected from the group consisting of norbornene, tetracyclododecene, and their alkyl-substituted monomers are particularly preferred.

Examples of the alkyl group in the above-mentioned alkyl-substituted monomers include alkyl groups having 1 to 6 carbon atoms, such as methyl, ethyl, propyl, butyl, pentyl, and hexyl. Examples of the alkenyl group in the alkenyl-substituted monomers include alkenyl groups having 2 to 6 carbon atoms, such as vinyl, allyl, butenyl, pentenyl, hexenyl, and cyclohexenyl. Examples of the alkylidene group in the alkylidene-substituted monomers include alkylidene groups having 1 to 6 carbon atoms, such as ethylidene, propylidene, butylidene, and hexylidene. Examples of the aryl group in the aryl-substituted monomers include phenyl, tolyl, and naphthyl.

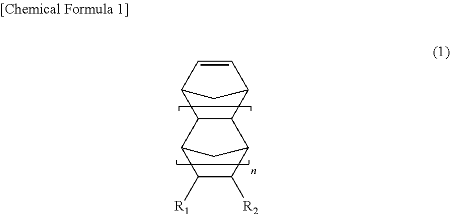

(in the formula (1), R₁ and R₂ are each independently a hydrogen atom or an alkyl group having 1 to 6 carbon atoms, and n is 0 or 1.)

Particularly, a monomer selected from the group consisting of norbornene or its alkyl-substituted monomers (in the general formula (1), n=0) is more preferred from the viewpoint of well attaining both heat resistance and flexibility.

The monomer component constituting the above-mentioned resin (A) may contain other monomers copolymerizable with the above-mentioned cycloolefin-based monomer (a1) and it preferably further contains, for example, an alkene monomer (a2) represented by the following general formula (2). Examples of the alkene monomer (a2) include α-olefins, such as ethylene, propylene, 1-butene, isobutene, and 1-hexene. The above-mentioned alkene monomer (a2) may be either linear or branched.

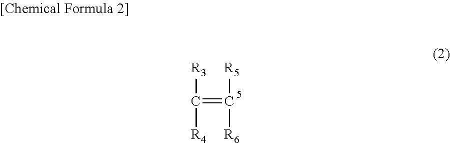

(in the formula (2), R₃ to R₆ are each independently a hydrogen atom or an alkyl group having 1 to 4 carbon atoms.)

The monomer component constituting the above-mentioned resin (A) is preferably accounted for 50% by mass or more by the above-mentioned cycloolefin-based monomer (a1) and is more preferably accounted for 60% by mass or more by the above-mentioned cycloolefin-based monomer (a1). When the cycloolefin-based monomer (a1) accounts for less than 50% by mass of the whole of the monomer component, adhesive strength under a high temperature environment tends to become insufficient.

In suppressing generation of gas under high temperatures, the above-mentioned resin (A) is preferably a binary copolymer having no polar groups, such as a resin produced by polymerizing a monomer component composed of the cycloolefin-based monomer (a1) represented by the aforementioned formula (1) and the alkene monomer (a2) represented by the aforementioned formula (2).

The polymerization method, the polymerization conditions, and the like to be used in polymerizing the aforementioned monomer component have no particular limitations and they may be determined appropriately according to a conventional method.

Examples of commercial products usable as the resin (A) include “TOPAS” produced by Polyplastics Co., Ltd., “APEL” produced by Mitsui Chemicals, Inc., “ZEONOR” and “ZEONEX” produced by Nippon Zeon Co., Ltd., and “ARTON” produced by JSR Corporation.

It is important that the glass transition point (Tg) of the above-mentioned resin (A) is 60° C. or higher. Preferably, the glass transition point of the resin (A) is 70° C. or higher. If the glass transition point of the resin (A) is lower than 60° C., the adhesive composition is softened when it is exposed to a high temperature environment, resulting in defective adhesion.

The resin (B) in the present invention is at least one resin selected from the group consisting of a terpene-based resin, a rosin-based resin, and a petroleum resin. Specifically, examples of the terpene-based resin include terpene resins, terpene phenol resins, modified terpene resins, hydrogenated terpene resins, and hydrogenated terpene phenol resins, examples of the rosin-based resin include rosin, rosin ester, hydrogenated rosin, hydrogenated rosin ester, polymerized rosin, polymerized rosin ester, and modified rosin, and examples of the petroleum resin include aliphatic or aromatic petroleum resins, hydrogenated petroleum resins, modified petroleum resins, alicyclic petroleum resins, and cumarone-indene petroleum resins. Among these, hydrogenated terpene resins and hydrogenated petroleum resins are preferred.

It is important that the softening point of the resin (B) is from 80 to 160° C. If the softening point of the resin (B) is lower than 80° C., the adhesive composition is softened when it is exposed to a high temperature environment, resulting in defective adhesion. On the other hand, if the softening point of the resin (B) exceeds 160° C., the peeling rate in peeling the adhesive composition becomes low.

It is important the molecular weight of the resin (B) is from 300 to 3000. If the molecular weight of the resin (B) is lower than 300, heat resistance becomes insufficient, so that the amount of degassing increases under a high temperature environment. On the other hand, if the molecular weight of the resin (B) exceeds 3000, the peeling rate in peeling the adhesive composition becomes low. The molecular weight of the resin (B) in the present invention means a molecular weight in terms of polystyrene measured by gel permeation chromatography (GPC).

The blending ratio of the resin (A) to the resin (B) is (A):(B)=80:20 to 55:45 (mass ratio). If the resin (A) is used more than the aforementioned range (in other words, the resin (B) is used less than the aforementioned range), the peeling rate in peeling the adhesive composition becomes low. On the other hand, if the resin (A) is used less than the aforementioned range (in other words, if the resin (B) is used more than the aforementioned range), the adhesive composition is softened when it is exposed to a high temperature environment, resulting in defective adhesion.

While the aforementioned organic solvent (S) is not particularly restricted if it can dissolve the resin (A) and the resin (B), preferred examples thereof include hydrocarbon solvent and terpene-based solvents are more preferred. The organic solvent (S) may be either a single solvent or two or more solvents.

Examples of the terpene-based solvent include α-pinene, camphene, pinane, myrcene, dihydromyrcene, p-menthane, 3-carene, p-menthadiene, α-terpinene, β-terpinene, α-phellandrene, ocimene, limonene, p-cymene, γ-terpinene, terpinolene, 1,4-cineole, 1,8-cineole, rose oxide, linalool oxide, fenchone, α-cyclocitral, ocimenol, tetrahydrolinalol, linalool, tetrahydromugol, isopulegol, dihydrolinalool, isodihydro lavendulol, β-cyclocitral, citronellal, L-menthone, linalyl formate, dihydroterpineol, β-terpineol, menthol, myrcenol, L-menthol, pinocarveol, α-terpineol, γ-terpineol, nopol, myrtenol, dihydrocarveol, citronellol, myrtenal, dihydrocarvone, d-pulegone, geranyl ethyl ether, geranyl formate, neryl formate, terpinyl formate, isodihydro lavendulyl acetate, terpinyl acetate, linalyl acetate, mycenyl acetate, bornyl acetate, menthyl propionate, linalyl propionate, nerol, carveol, perillylalcohol, geraniol, safranal, citral, perillaldehyde, citronellyloxyacetaldehyde, hydroxycitronellal, verbenone, d-carvone, L-carvone, piperitone, piperitenone, citronellyl formate, isobornyl acetate, menthyl acetate, citronellyl acetate, carvyl acetate, dimethyloctanyl acetate, nellyl acetate, isopulegol acetate, dihydrocarvyl acetate, nopyl acetate, geranyl acetate, bornyl propionate, neryl propionate, carvyl propionate, terpinyl propionate, citronellyl propionate, isobornyl propionate, linalyl isobutyrate, neryl isobutyrate, linalyl butyrate, neryl butyrate, terpinyl isobutyrate, terpinyl butyrate, geranyl isobutyrate, citronellyl butyrate, citronellyl hexanoate, menthyl isovalerate, β-caryophyllene, cedrene, bisabolene, hydroxycitronellol, farnesol, and rhodinyl isobutyrate. Among these, at least one of limonene and p-menthane is preferably used as the terpene-based solvent from the viewpoint of solubility, and particularly preferred is p-menthane.

The solid concentration (namely, the proportion accounted for by the total mass of the resin (A) and the resin (B) to the total mass of the resin (A), the resin (B), and the organic solvent (S)) of the adhesive composition of the present invention is usually from 20 to 60% by mass.

The adhesive composition of the present invention is, if needed, allowed to contain additives, such as a plasticizer and an antioxidant, in addition to the resin (A), the resin (B), and the organic solvent (S) as far as the effect of the present invention is not impaired.

The adhesive composition of the present invention can form an adhesive layer having heat resistance as high as no defective adhesion is caused by degradation of resin or generation of gas even upon exposure to high temperature and exhibiting sufficient resistance to various types of chemical liquids to be used for a photoresist or the like. Moreover, the adhesive layer can be peeled rapidly by treatment such as immersion in a prescribed solvent when it has become unnecessary. One representative example of the various types of chemical liquids to be used for a photoresist or the like is PGMEA, and other examples include the chemical liquids used in the evaluation of resistance to chemical liquid in examples provided below. Examples of the solvent to be used in peeling the adhesive layer formed from the adhesive composition of the present invention (hereinafter referred to as “peeling solvent”) include solvents the same as the examples of the organic solvent (S). Preferably, a solvent that is the same as that used as the organic solvent (S) is used as a peeling solvent.

### EXAMPLES

The present invention is described in more detail below with reference to examples, but the invention is not limited thereto.

As to evaluation of an adhesive composition, a coating film was formed on a silicon wafer by using the adhesive composition, and the evaluation was carried out by using the resulting silicon wafer with a coating film as a specimen according to the following test methods.

The specimen was prepared by applying the obtained adhesive composition onto a 6-inch silicon wafer so that the dry film thickness might become 15 μm and drying the composition at 110° C. for 3 minutes, then at 150° C. for 3 minutes, and subsequently at 200° C. for 3 minutes. A specimen to be used for evaluation of the flexibility of the coating film was prepared by modifying the foregoing method to apply the adhesive composition so that the dry film thickness might become 50 μm and then drying the composition at 150° C. for 3 minutes and subsequently at 200° C. for 3 minutes.

### <Peelability>

A specimen (silicon wafer with a coating film) was immersed in p-menthane held at 23° C., and 5 minutes later the condition of the coating film was observed visually. The case that the coating film layer had been dissolved completely was judged as “∘”, whereas the case that the coating film layer remained undissolved was judged as “x”. Moreover, the specimen was kept immersed in p-menthane until its coating film dissolved completely and the time taken before the coating film dissolved completely was measured. Then, a dissolution rate (L/T (nm/sec)) was calculated from the dissolution time (T (sec)) and the thickness (L (nm)) of the coated film on the specimen measured beforehand. In point of productivity, the dissolution rate is preferably 60 nm/sec or more.

### <Resistance to Chemical Liquid>

Various types of chemical liquids to be used for a photoresist or the like were held at 23° C., and then specimens (silicon wafers with a coating film) were immersed therein and five minutes later the condition of a coating film was observed visually. The case that neither a crack nor a dissolved part were found was judged as “∘”, whereas the case that at least one of a crack or a dissolved part was found was judged as “x” Evaluation was carried out using the following materials (abbreviation is within parentheses) as chemical liquids.

Propylene glycol monomethyl ether acetate (PGMEA)

Water

Isopropyl alcohol (IPA)

Propylene glycol monomethyl ether (PGME)

N-methylpyrrolidone (NMP)

Dimethyl sulfoxide (DMSO)

2.38% by mass aqueous solution of tetramethylammonium hydroxide (TMAH)

5% by mass aqueous solution of sodium hydroxide (NaOH)

1% by mass aqueous solution of hydrogen fluoride (1-HF)

3% by mass aqueous solution of hydrogen fluoride (3-HF)

### <Flexibility of a Coating Film>

As described above, a specimen (silicon wafer with a 50 μm thick coating film) obtained by changing dry film thickness and drying conditions was observed visually, and the case that no crack was found in the coating layer was judged as “∘”, whereas the case that a crack was found in the coating layer was judged as “x”.

### <Heat Resistance (Gas Generation)>

A specimen (silicon wafer with a coating film) was increased in temperature from 40° C. to 250° C., and then the amount of gas generated from the coating film (amount of degassing) was measured under the following conditions according to the TDS method (Thermal Desorption Spectroscopy) by using a TDS measurement apparatus (Emitted gas measurement apparatus; “EMD-WA1000” produced by ESCO, Ltd.).

[Conditions of TDS measurement apparatus]

Width: 100

Center Mass Number: 50

Gain: 9

Scan Speed: 4

Emult Volt: 1.3 kV

Then, the case that the intensities at 100° C. and at 200° C. measured by using the TDS measurement apparatus were less than 10000 was judged as “∘”, whereas the case that at least one of the intensities was 10000 or more was judged as “x”.

Usually, the amount of degassing measured at a temperature up to 100° C. is the amount of water vapor originated in moisture which was absorbed by the adhesive composition or azeotropic gas of the water vapor, and the amount of degassing measured at a temperature higher than 100° C. is the amount of gas generated due to thermal decomposition of the adhesive composition itself. Therefore, the heat resistance of the adhesive composition can be evaluated comprehensively by examining the intensity (amount of degassing) at 100° C. and the intensity (amount of degassing) at 200° C.

### <Heat Resistance (Resin Degradation)>

A specimen (silicon wafer with a coating film) was heated at 230° C. for 1 hour and then it was immersed in p-menthane held at 23° C. Five minutes later the condition of the coating film was observed visually; the case that the coating film layer had been dissolved completely was judged as “∘”, whereas the case that the coating film layer remained undissolved was judged as

### Examples 1 to 3 and Comparative Examples 1 to 4

As the resin (A), a cycloolefin copolymer produced by copolymerizing norbornene with ethylene using a metallocene catalyst (“TOPAS 8007” produced by Polyplastics Co., Ltd., norbornene:ethylene=65:35 (mass ratio), glass transition point: 70° C., Mw: 98200, Mw/Mn: 1.69) was used. As the resin (B), a hydrogenated terpene resin (“Clearon P135” produced by Yasuhara Chemical Co., Ltd., softening point: 135° C., molecular weight: 820; this is referred to as “terpene resin (1)”) was used. The resin (A) and the resin (B) were dissolved in the proportions given in Table 1 in a terpene-based solvent (p-menthane), so that adhesive compositions with a solid concentration of 30% by mass were obtained.

TABLE 1

| | | Comparative | | | | Comparative | Comparative | Comparative |
|---|---|---|---|---|---|---|---|---|
| | | Example 1 | Example 1 | Example 2 | Example 3 | Example 2 | Example 3 | Example 4 |
| Resin (A) (parts by mass) | | 100 | 75 | 65 | 58 | 50 | 35 | 0 |
| Resin (B) (Terpene Resin (1)) (parts by mass) | | 0 | 25 | 35 | 42 | 50 | 65 | 100 |
| Peelability | Condition of Coating Film | ∘ | ∘ | ∘ | ∘ | ∘ | ∘ | ∘ |
| | Dissolution rate(nm/sec) | 51.4 | 67.0 | 84.2 | 90.0 | 101.0 | 240.0 | 490.0 |
| Resistance | PGMEA | ∘ | ∘ | ∘ | ∘ | x | x | x |
| to Chemical | Water | ∘ | ∘ | ∘ | ∘ | ∘ | ∘ | ∘ |
| Liquid | IPA | ∘ | ∘ | ∘ | ∘ | ∘ | ∘ | ∘ |
| | PGME | ∘ | ∘ | ∘ | ∘ | ∘ | ∘ | ∘ |
| | NMP | ∘ | ∘ | ∘ | ∘ | ∘ | ∘ | ∘ |
| | DMSO | ∘ | ∘ | ∘ | ∘ | ∘ | ∘ | ∘ |
| | TMAH | ∘ | ∘ | ∘ | ∘ | ∘ | ∘ | ∘ |
| | NaOH | ∘ | ∘ | ∘ | ∘ | ∘ | ∘ | ∘ |
| | 1-HF | ∘ | ∘ | ∘ | ∘ | ∘ | ∘ | ∘ |
| | 3-HF | ∘ | ∘ | ∘ | ∘ | ∘ | ∘ | ∘ |
| Flexibility of Coating Film | | ∘ | ∘ | ∘ | ∘ | x | x | x |
| Heat | Gas Generation | ∘ | ∘ | ∘ | ∘ | ∘ | ∘ | x |
| Resistance | Resin Degradation | ∘ | ∘ | ∘ | ∘ | ∘ | ∘ | ∘ |

### Examples 4 to 6 and Comparative Examples 5 to 8

The cycloolefin copolymer (“TOPAS 8007” produced by Polyplastics Co., Ltd.) used in Examples 1 to 3 and Comparative Examples 1 to 4 was used as the resin (A). A hydrogenated terpene resin (“Clearon P115” produced by Yasuhara Chemical Co., Ltd., softening point: 115° C., molecular weight: 650; this is referred to as “terpene resin (2)”) was used as the resin (B). The resin (A) and the resin (B) were dissolved in the proportions given in Table 2 in a terpene-based solvent (p-menthane), so that adhesive compositions with a solid concentration of 30% by mass were obtained.

TABLE 2

| | | Comparative | | | | Comparative | Comparative | Comparative |
|---|---|---|---|---|---|---|---|---|
| | | Example 5 | Example 4 | Example 5 | Example 6 | Example 6 | Example 7 | Example 8 |
| Resin (A) (parts by mass) | | 100 | 75 | 65 | 58 | 50 | 35 | 0 |
| Resin (B) (Terpene Resin (2)) (parts by mass) | | 0 | 25 | 35 | 42 | 50 | 65 | 100 |
| Peelability | Condition of Coating Film | ∘ | ∘ | ∘ | ∘ | ∘ | ∘ | ∘ |
| | Dissolution rate(nm/sec) | 51.4 | 82.5 | 97.0 | 99.0 | 102.0 | 250.0 | 500.0 |
| Resistance | PGMEA | ∘ | ∘ | ∘ | ∘ | x | x | x |
| to Chemical | Water | ∘ | ∘ | ∘ | ∘ | ∘ | ∘ | ∘ |
| Liquid | IPA | ∘ | ∘ | ∘ | ∘ | ∘ | ∘ | ∘ |
| | PGME | ∘ | ∘ | ∘ | ∘ | ∘ | ∘ | ∘ |
| | NMP | ∘ | ∘ | ∘ | ∘ | ∘ | ∘ | ∘ |
| | DMSO | ∘ | ∘ | ∘ | ∘ | ∘ | ∘ | ∘ |
| | TMAH | ∘ | ∘ | ∘ | ∘ | ∘ | ∘ | ∘ |
| | NaOH | ∘ | ∘ | ∘ | ∘ | ∘ | ∘ | ∘ |
| | 1-HF | ∘ | ∘ | ∘ | ∘ | ∘ | ∘ | ∘ |
| | 3-HF | ∘ | ∘ | ∘ | ∘ | ∘ | ∘ | ∘ |
| Flexibility of Coating Film | | ∘ | ∘ | ∘ | ∘ | x | x | x |
| Heat | Gas Generation | ∘ | ∘ | ∘ | ∘ | ∘ | ∘ | x |
| Resistance | Resin Degradation | ∘ | ∘ | ∘ | ∘ | ∘ | ∘ | ∘ |

### Examples 7 to 9 and Comparative Examples 9 to 12

The cycloolefin copolymer (“TOPAS 8007” produced by Polyplastics Co., Ltd.) used in Examples 1 to 3 and Comparative Examples 1 to 4 was used as the resin (A). A hydrogenated terpene resin (“Clearon P105” produced by Yasuhara Chemical Co., Ltd., softening point: 105° C., molecular weight: 630; this is referred to as “terpene resin (3)”) was used as the resin (B). The resin (A) and the resin (B) were dissolved in the proportions given in Table 3 in a terpene-based solvent (p-menthane), so that adhesive compositions with a solid concentration of 30% by mass were obtained.

TABLE 3

| | | Comparative | | | | Comparative | Comparative | Comparative |
|---|---|---|---|---|---|---|---|---|
| | | Example 9 | Example 7 | Example 8 | Example 9 | Example 10 | Example 11 | Example 12 |
| Resin (A) (parts by mass) | | 100 | 75 | 65 | 58 | 50 | 35 | 0 |
| Resin (B) (Terpene Resin (3)) (parts by mass) | | 0 | 25 | 35 | 42 | 50 | 65 | 100 |
| Peelability | Condition of Coating Film | ∘ | ∘ | ∘ | ∘ | ∘ | ∘ | ∘ |
| | Dissolution rate(nm/sec) | 51.4 | 80.0 | 109.0 | 114.0 | 130.0 | 272.0 | 520.0 |
| Resistance | PGMEA | ∘ | ∘ | ∘ | ∘ | x | x | x |
| to Chemical | Water | ∘ | ∘ | ∘ | ∘ | ∘ | ∘ | ∘ |
| Liquid | IPA | ∘ | ∘ | ∘ | ∘ | ∘ | ∘ | ∘ |
| | PGME | ∘ | ∘ | ∘ | ∘ | ∘ | ∘ | ∘ |
| | NMP | ∘ | ∘ | ∘ | ∘ | ∘ | ∘ | ∘ |
| | DMSO | ∘ | ∘ | ∘ | ∘ | ∘ | ∘ | ∘ |
| | TMAH | ∘ | ∘ | ∘ | ∘ | ∘ | ∘ | ∘ |
| | NaOH | ∘ | ∘ | ∘ | ∘ | ∘ | ∘ | ∘ |
| | 1-HF | ∘ | ∘ | ∘ | ∘ | ∘ | ∘ | ∘ |
| | 3-HF | ∘ | ∘ | ∘ | ∘ | ∘ | ∘ | ∘ |
| Flexibility of Coating Film | | ∘ | ∘ | ∘ | ∘ | x | x | x |
| Heat | Gas Generation | ∘ | ∘ | ∘ | ∘ | ∘ | ∘ | x |
| Resistance | Resin Degradation | ∘ | ∘ | ∘ | ∘ | ∘ | ∘ | ∘ |

1. An adhesive composition comprising a resin (A) produced by polymerizing a monomer component containing a cycloolefin-based monomer (a1), at least one resin (B) selected from the group consisting of a terpene-based resin, a rosin-based resin, and a petroleum resin, and an organic solvent (S) capable of dissolving the resins (A) and (B), wherein
the resin (A) has a glass transition point of 60° C. or higher,
the resin (B) has a softening point of 80 to 160° C. and a molecular weight of 300 to 3000, and
the blending ratio of the resin (A) to the resin (B) is (A):(B)=80:20 to 55:45 (mass ratio).

2. The adhesive composition according to claim 1, wherein the monomer component constituting the resin (A) is accounted for 50% by mass or more by the cycloolefin-based monomer (a1).

3. The adhesive composition according to claim 1, wherein the monomer component constituting the resin (A) further comprises an alkene monomer (a2).

4. The adhesive composition according to claim 1, wherein the cycloolefin-based monomer (a1) is a norbornene-based monomer.

5. The adhesive composition according to claim 1, wherein the organic solvent (S) is a terpene-based solvent.

6. A method for processing a substrate comprising the steps of:
temporarily fixing a support to a substrate with an adhesive layer interposed therebetween,
processing the substrate including the step of heating the substrate, and
peeling the support from the substrate with a solvent, wherein
the adhesive layer is formed from the adhesive composition according to claim 1.

7. The processing method according to claim 6, wherein the substrate is a wafer.

8. The processing method according to claim 6, wherein the solvent with which the support is peeled from the substrate is the same solvent as the solvent (S) used for the adhesive composition.
